(19) United States
(12) Patent Application Publication
(10) Pub. No.: US 2024/0086416 A1
(43) Pub. Date: Mar. 14, 2024

(54) METHODS AND SYSTEMS FOR INTEGRATING EXTERNAL SYSTEMS OF RECORDS WITH FINAL REPORT

(71) Applicant: Honeywell International Inc., Charlotte, NC (US)

(72) Inventors: Ankit Singh, Apex, NC (US); Timothy Sneed, Charlotte, NC (US); Arun Ramasubrahmanyan, Burlington, NJ (US); Judith Fainor, Doylestown, PA (US)

(21) Appl. No.: 17/930,925

(22) Filed: Sep. 9, 2022

(51) Int. Cl. G06F 16/25

(52) U.S. Cl. CPC G06F 16/254

(57) ABSTRACT

A method of accessing data from disparate data sources at a data access layer, the method comprising: receiving a request to ingest raw data from a plurality of systems of record; ingesting raw data from the plurality of systems of record based on the received request to ingest raw data; mapping the ingested raw data to a plurality of unpopulated enterprise object models to standardize the ingested raw data and to populate the enterprise object models; storing the standardized data and the plurality of populated enterprise object models; and providing the plurality of populated enterprise object models to the data access layer for accessing the standardized data.

### TECHNICAL FIELD

The present disclosure relates generally to systems and methods for integrating disparate data into a common system and more specifically, to systems and methods for integrating disparate data from systems of record into a common system using an enterprise object model framework.

### BACKGROUND

Pharmaceutical companies and other companies can be subject to in-depth internal and external reviews of their practices and products. One way for companies to prepare for in-depth external reviews is by carefully conducting annual product and process reviews. For example, companies may generate one or more annual product reviews and/or annual product quality reviews (APQR). Such reviews may be internal to a firm and may be based on data from numerous distinct data sources (e.g., databases) with disparate formatting, metadata, etc. Because the review may be generated from so many different and dissimilar sources, and because the final report generated from the review may be subject to careful, multi-level review before its publishing, the generation and approval of such reviews/reports may take months, if not years, expending countless person-hours. These person-hours of painstaking aggregation, review, comment, correction, and approval consume valuable resources that could be more profitably expended elsewhere. Accordingly, automated systems for the generation and approval of reviews are required.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

In one embodiment, a method of accessing data from disparate data sources at a data access layer, the method comprising: receiving a request to ingest raw data from a plurality of systems of record; ingesting raw data from the plurality of systems of record based on the received request to ingest raw data; mapping the ingested raw data to a plurality of unpopulated enterprise object models to standardize the ingested raw data and to populate the enterprise object models; storing the standardized data and the plurality of populated enterprise object models; and providing the plurality of populated enterprise object models to the data access layer for accessing the standardized data.

In another embodiment, a method for providing data for presentation in a report through a data access layer, the method comprising: ingesting raw data from a plurality of systems of record based on a received request to ingest raw data; providing the ingested raw data to an integration framework for integration of the raw data to a plurality of enterprise object models as integrated data; storing the integrated data; populating a plurality of enterprise object models with the integrated data based on a user request; providing the plurality of populated enterprise object models to a data access layer for accessing the integrated data and generating one or more reports based on the integrated data.

In yet another embodiment, a system for providing processed data to a data access layer for the generation of a data-based product, the system comprising: a processor communicatively coupled to a plurality of external systems of record; a memory including one or more instructions that when executed by the processor cause the system to: ingest raw data from at least one of the plurality of systems of record based on a received request to ingest raw data; provide the ingested raw data to an integration framework for integration of the raw data to a plurality of enterprise object models as integrated data; store the integrated data; populate a plurality of enterprise object models with the integrated data based on a user request; and provide the plurality of populated enterprise object models to a data access layer for accessing the integrated data and generating one or more reports based on the integrated data.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

Embodiments of the disclosure will now be described, by way of example only, with reference to the accompanying drawings in which:

FIG. 1 illustrates a system for integrating data from various systems of record to generate a final product, according to one or more embodiments shown and described herein.

FIG. 2 illustrates a tech fabric component of the system of FIG. 1.

FIG. 3 illustrates an infrastructure for generating a final product using the tech fabric component of FIG. 2.

FIG. 4 illustrates a flow chart for implementing embodiments of the system of FIG. 1.

FIG. 5 illustrates a second flow chart for alternative implementations of embodiments of the system of FIG. 1.

### DETAILED DESCRIPTION

Annual Product Quality Reviews (APQRs) may be required, especially for pharmaceutical companies and other companies in the pharmaceutical and life sciences industries. Companies may generally review and produce products annually, and reviews of those new/updated products may help ensure product and process quality through the regular assessment and validation of products and procedures. An APQR may include, for example, information about an entire batch of a particular pharmaceutical product (e.g., a mediation, etc.). The data used to generate such a report is vast and the systems from which such data is drawn are often disparate and ill communicating. Thus, connecting such systems may involve excessively laborious and careful effort, and, in particular, manual review and processing of large chunks of data from different sources. This review may be completed by individuals at all levels within an organization. Because this process can require so much effort, tools for automating the process are desired. The systems and methods described herein provide such automating tools.

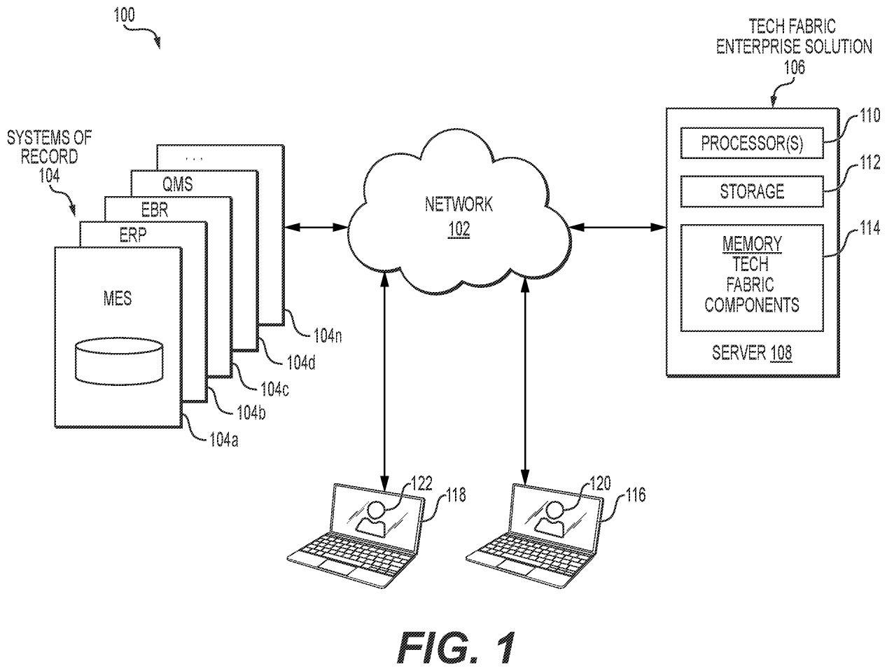

FIG. 1 illustrates an example of a computing environment 100 including a network 102 configured to communicatively connect one or more systems of record (SOR) 104 to a tech fabric enterprise solution 106 for providing data from the systems of record 104 for analysis in an annual product quality review (APQR) using the tech fabric 106. The computing environment (system) 100 or portions thereof, including the network 102, can be any type of communication network, including, for example, a wireless local area network (WLAN), a cloud network, the Internet, etc.

The SOR 104 may include, for example, a manufacturing execution systems (MES) 104a, an enterprise resource planning (ERP) system 104b, an electronic batch record (EBR) 104c, a quality management system (QMS) 104d, and one or more additional systems of record. The SOR 104 may represent available data sources that include relational data repositories and operational data stores including structured and unstructured data (e.g., collections of files, documents, sheets, etc.). In some embodiments, the SOR 104 may include and/or be configured to provide real time data. The SOR 104 may be implemented, for example, on a computer system running a database management system and may serve as an authoritative source of data for a given data element (or other piece of information) within that computer system and for other computers or computer networks communicating with that computer system (e.g., the network 102). Accordingly, if different systems or computers within the network 102 disagree about a given piece of information, the data contained within the SOR 104 may control. Disagreements could stem from, for example, semantic differences, uses of different resources in different ways at different times, differences in timing, extraction, transformation, loading, and other processes that create and/or manipulate data that the various computers and systems on the network 102 report against. In some cases, differences in data may be the result of one or more inconsistencies or bugs within the various components of the system. Hence, the SOR 104 may serve as a valid data source when there is no valid, traceable source. Because the reports generated using the data from these various SOR 104 is generally data for consumers of data who have generally similar needs (i.e., the generation and approval of a single report), the use of systems of record to provide verified, consistent data may be preferable to other types of data incorporation, such as in systems that require most recent data or data which has been individually vetted.

Examples of information stored in the SOR 104 include information related to, for example, customer services, sales, procurement, production, distribution, accounting, human resources, corporate performance and government, etc.

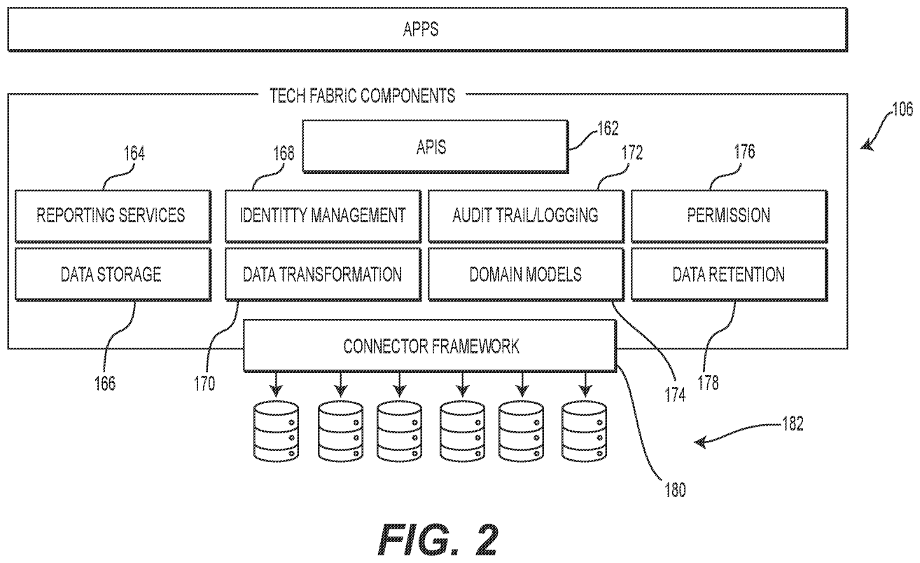

In some embodiments, the tech fabric enterprise solution 106 may be implemented by a computer system which may include, for example, a server 108 including one or more processors 110 and a memory 114 which may include the components of the tech fabric 106, which is shown in greater detail in FIG. 2. The applications of the tech fabric 106 may be implemented, for example, by the one or more processors 110. The computer system may include any type of computing device(s), including any type of server systems (e.g., virtualized, stand-alone, etc.) The computer system may be operated using an operating system (OS), for example, Windows, Linux, UNIX, etc. The processor 110 may be a single or multiple microprocessors. The memory 114 may be a random access memory and may comprise one or more memory modules. The storage 112 may be any type of storage device including disc storage, solid state storage device, etc.

The network 102 may be accessed using, for example, a computing device 116 and a computing device 118, which devices may be configured to grant access to the network 102 to one or more users, for example, a systems admin 120 and a business admin 122. The systems admin 120 may have access to certain aspects of the tech fabric administration, such as the systems of record integrations and mappings from the systems of record raw data fields to various enterprise object models as described in greater detail herein. The business admin 122 may have configuration responsibilities for various other aspects within one or more final reports generated using the tech fabric enterprise solution 106 and within the tech fabric enterprise solution 106 itself.

Referring now to FIG. 2, additional details are provided with respect to the tech fabric 106. The tech fabric 106 may include an API module 162, a reporting services module 164, a data storage module 166, an identity management module 168, a data transformation module 170, an audit trail/logging module 172, a domain models module 174, a permissions module 176, and a data retention module 178. The various modules may provide data to a connector framework 180 for sending the processed data to one or more databases 182.

The APIs module 162 may provide one or more users (e.g., the systems admin 120, the business admin 122, etc.) and/or developers with one or more tools (e.g., wizards, UIs, etc.) to design, test, implement, deploy, and manage APIs for use across the environment 100. A user can create one or more intermediaries (e.g., software applications) that may make it possible to read, convert, present, use, manipulate, or otherwise access the data on the SOR 104 for presentation or other use in a generated product. The APIs module 162 may be cloud-based or locally accessible by one or more users (e.g., the systems admin 120, the business admin 122, etc.).

The APIs module 162 may be used to, for example, create one or more programs for various programs or applications on computers and/or computer systems within the network 102 to communicate with one another. In some embodiments, the APIs module 162 may include an API specification, which may describe how to build and/or use one or more of the APIs built using the API module 162 or otherwise within the network 102. The APIs module 162 may include one or more subroutines, methods, requests, or endpoints, which subroutines, methods, requests, and endpoints may be tools used to program the one or more APIs. The APIs module 162 may be used to generate one or more APIs for specific reports built using the systems and methods described herein.

In some embodiments the APIs module 162 may be used to build one or more web APIs, which may allow communication between one or more computers or computer systems which may connect the network 102 with another external network (e.g., the Internet). In some embodiments, the web APIs may allow access to one or more computers or computer systems communicatively coupled to the network 102 through one or more client devices (E.g., mobile phones, laptops, etc.), which devices may connect to the network using, for example, the hypertext transfer protocol (HTTP). These client devices may send a request in the form of an HTTP request, which request may be met with a response message in a different format (e.g., JavaScript Object Notation (JSON), extensible markup language (XML), etc.) In some embodiments, one or more users may use a web API (e.g., a web API created by the APIs module 162) to query the one or more SOR 104 for a specific set of data from one or more of the SOR 104.

The APIs module 162 may include a language binding API that may provide glue code that may allow one or more programming languages to use a foreign library or operating system service (e.g., one that is not native to the particular language). The language binding API may map or bridge one programming language to another so that a library written for one language may be used in a different language. For example, one or more of the SOR 104 may have one or more functions written in C or C++ and the language binding API may bind the C or C++ language to a higher level code such as, for example, Python, Lua, Java, Common Lisp, etc. The binding may be based on recompiled code or a foreign function interface, such as, for example “ctypes.”

The reporting services module 164 may aggregate usage information for various aspects (e.g., files, data, etc.) and may report the usage information to one or more of the various interconnected systems or modules (e.g., the APIs module 162, the network 102, etc.) For example, if a particular file or data is accessed and/or used, the reporting services module 164 may aggregate data regarding the use of that particular information and report it to one or more internal modules or external systems. The reporting services module 164 may further generate information regarding, for example, statistical information on the amount of usage of the tech fabric enterprise solution 106 or other components of the system 100.

The data storage module 166 may include one or more storage drives configured to retrieve stored data in response to one or more storage commands received from the system 100 (e.g., from the system admin 120). The data storage module 166 may include hardware and software components, for example, the data storage module 166 may include a plurality of storage drives (e.g., solid state drives) that may be configured to store and retrieve data in response to storage instructions. Portions of the storage module 166 may be implemented using software modules, such as drivers, services, and/or the like. Other portions of the storage module 166 may be implemented using hardware resources, such as FPGAs, processors, ASICS, hardware controllers, storage controllers, and the like.

The data storage module 166 may include and/or communicatively couple to one or more elements of physical support structure (e.g., an enclosure), which support structure may include one or more printed circuit boards, circuitry, semiconductor systems, and one or more other structural elements. The physical components may be, for example, insertable and removable from a rackmount style of enclosure. In some embodiments, the data storage module 166 and/or one or more of its components may include devices which may provide self-power during, for example, a power interruption event such that the storage components and those communicatively coupled with the storage components maintain power via a backup or auxiliary means until a primary source of power (e.g., the electric grid) can be restored.

The identity management module 168 may provide identity services such as access management and authorization services to the tech fabric 106. The identify management module 168 may control information about tenants and clients which may utilize the services provided by tech fabric 106. Information used and generated by the identity management module 168 may include authenticating information that identifies users and assigns the users appropriate authorizations for particular system resources. In some embodiments, the identity management module 169 may include a framework of policies and technologies that may safeguard the network 102 such that the correct users (e.g., that are part of the ecosystem connected to the network 102) have the appropriate access to the appropriate tech resources. The identity management module 168 may enable users to create and/or gain an identity within the ecosystem, assign the created/gained users or other users one or more roles within the ecosystem, and may assign permissions and/or identity grants to the users. The identity management module 169 may store and make available the identities and the technologies supporting that protection (e.g., network protocols, digital certificates, passwords, etc.)

The identity management module 168 may serve various functions throughout multiple stages of a user's interaction with the network 102. For example, during a registration phase and during an operation phase. During the registration (or configuration) phase, the identity management module 168 may register and authorize access rights. During the operations phase the identity management module 168 may continuously identify, authenticate, and control the individual identities and/or groups of identities with access to the various hardware and/or software systems of the network 102. The identity management module 168 may serve, for example, five basic functions: pure identity, user access (e.g., log-on), presence-based services, identity federation, and audit function. In some embodiments, particular one(s) of the various SOR 104 and/or modules of the system may be accessible by only various users of the network 102 with granted access and the identity management module 168 may identify and record which users have access to such SOR 104 and/or modules.

In some embodiments, the identity management module 168 may communicatively couple with one or more external identity management systems, which system(s) may perform one or more of the functions described herein with respect to identity management external of the network 102. One or more users (e.g., the user admin 120, the business admin 122, etc.) may assign the various credentials and other permissions associated with a user's identity. In some embodiments, a user's identity may be associated with one or more cryptologic keys or other access keys, which may serve as a two-factor or multi-factor authentication key for verifying a user's identity.

The data transformation module 170 may be configured to transform, convert, and/or translate data acquired from the SOR 104 for use by the tech fabric 106. The transformation module 170 may be configured to parse data structures acquired from the SOR 104 and to transform the constituent data into a format that is compatible for use with one or more other components of the system 100 (e.g., one or more other modules or for storage in a database). The tech fabric 106 may comprise multiple data transformation modules 170 and each may be configured to transform data from one or more of the individual SORs 104a, 104b, etc. (e.g., data transformation modules that are specific to a particularly formatted data from a particularly formatted SOR). The data transformation module 170 can receive a user query and retrieve and transform unstructured or structured data in response to receiving the user query.

The audit trail/logging module 172 may be configured to track, in real time, a request for identity verification and any response thereto from any of the various users of the system 100. In some embodiments, the audit trail/logging module 172 may be configured to track or monitor services performed by various users of the system and by the various components of the system (e.g., one or more servers). The audit trail/logging module 172 may be configured to record a detailed log of actions and events which occur within the system 100 such that the system administrator 120 or other user may identify and locate sources of error.

The domain models module 174 may store one or more data relationships in a lexicon or term list associated with a particular industry for which the final product of the process will be generated. For example, the domain model module may store one or more data relationships in a term list associated with the life sciences industry. These domain models may be used to determine key words of interest or other information with respect to a particular final product. One or more storage devices (e.g., the raw data storage 130) may store a corpus, n-gram index, semantic graph, domain model, or other data used for automatic domain model generation. The domain models module 174 may include sets of one or more “intents” and one or more “slots,” for example. The intents may represent activities or arrangements that a user may request be performed on one or more entities in a relevant domain. For example, in a report generation domain, the intents may include an intent to “generate a chapter including all medicament ingredients.” Slots may represent parameters for actions or entities. For example, the “generate a chapter including all medicament ingredients” intent may be associated with a “ingredient” slot, which slot may correspond to a chapter to be autopopulated with data. Intent patterns or slot patterns may be associated with one or more intents and slots. These intent patterns and slot patterns may be associated with a natural language request to identify one or more intents and/or slots included in the requests. Patterns may include linguistic patterns, n-gram patterns, co-occurrence patterns, or any other pattern of query features.

The permissions module 176 may be configured to determine whether a user is authorized to access certain information and/or to perform a particular action within the system 100. The permissions module 176 may query permissions data stored in the system 100, which stored data may indicate required permissions associated with various actions or settings. Users may have varying levels of permission based on different actions/information. The permissions module 176 may access identity information for particular users and may analyze identity information to determine an identity of a user. In an example, the permissions module 176 can determine permissions of a user based at least in part on the identity of the user.

The data retention module 178 may be configured to detect a data retention triggering event and to initiate one or more data retention operations in response to detecting the data retention triggering event. For example, data may be retained in the memory 114 using one or more sets of write parameter values. In some embodiments, the data retention module 178 may be configured to delete all stored data in response to a triggering event. For example, all of a client's stored data may be deleted upon completion and delivery of an APQR. The data retention module 178 may be configured to initiate an autonomous storage operation or to create sufficient storage space for a particular operation. For example, the data retention module 178 may cause one or more data from the SOR 104 to be stored in a local module within the tech fabric 106 or other component of the system for later processing and manipulation (e.g., during report generation).

The connector framework 180 may be, for example, an object oriented framework which may facilitate communication between one or more application components (e.g., APIs) running in the tech fabric 106 and the one or more SOR 104. The connector framework 180 may include one or more protocol definitions for implementation by one or more connector components, which connector components may enable communication between the tech fabric 106 and the SOR 104, while simultaneously constraining same.

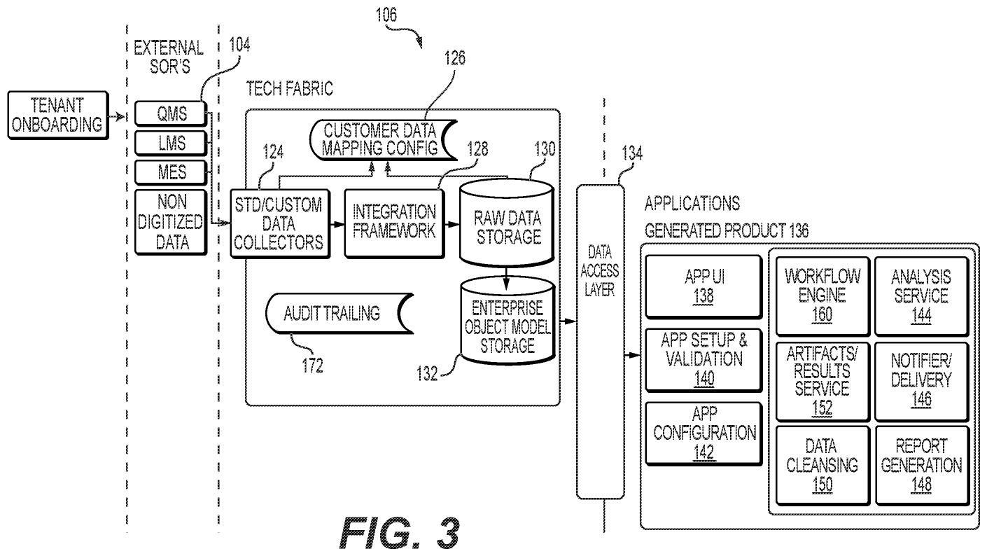

Referring now to FIG. 3, a chart for generating a final product using data integrated from numerous systems of record (SOR). Initially, a tenant may be onboarded for integration of the tenant's (i.e., client's) systems of record with the tech fabric 106. The tenant may be onboarded and may be given access to various tools within the system 100 which may exist in different environments (e.g., a customer relationship management (CRM) tool or a service oriented architecture (SOA)). In some embodiments, a tenant onboarding API may be configured to interface and allow an administrator to provide a particular tenant configuration, which configuration may be, for example, associated with a unique user identification (UUID) or a particular environment or environmental configuration. The particular tenant's SOR may be mapped to the tech fabric as will be described in greater detail herein.

As briefly mentioned above, each tenant may have different systems of record, which systems may contain disparate and dissimilar data, which must be integrated using the tech fabric 106 to generate the final product. The tech fabric 106 may be implemented using one or more connected systems or networks and its various components may be stored and implemented using connected systems or networks (e.g., in a data lake). The tech fabric 106 may include, for example, a standard/custom data collection module 124, a customer data mapping config module 126, an integration framework module 128, a raw data storage module 130, and an enterprise object model storage module 132. The tech fabric 106 may provide the enterprise object models to the data access layer 134 where they may be interactively accessed by the particular final generated product 136. The final generated product 136 may include an application user interface 138, an application setup and validation module 140, an application configuration module 142, a workflow engine 160, an artifacts/results service module 152, a data cleansing module 150, an analysis service module 144, a notifier/delivery module 146, and a report generation module 148. In some embodiments, the report may be, for example, an annual product quality review.

The data collection module 124 may include one or more subroutines or components (hardware and software) configured to query communicatively coupled SOR and acquire and collect accumulated data from the SOR 104 or subsets of SOR. The pattern and frequency of data collection may be defined, for example, by a user (e.g., system admin 120, business admin 122, etc.) In some embodiments, the pattern or time frame of data collection is based on a time frame for a given report. For example, a report that is produced using the described system 100 that covers an annual time frame may include data that is collected over a preceding year. In some embodiments, data may be collected over a quarter, or semi-annually, monthly, weekly, daily, or over any time frame. In some embodiments, data may be collected in real time from the SOR.

The customer data mapping config module 126 may include one or more sets of actions or rules (e.g., a template file) for mapping customer data from the various SOR 104 to the enterprise object models generated using the tech fabric 106. The customer data mapping config module 126 may include instructions or programs for extracting data fields from one or multiple source files and matching them to their related target fields in their destination files (e.g., the enterprise object models). The customer data mapping config module 126 may include rules for consolidating data by extracting, transforming, and loading it to a destination system (e.g., the EOM module) and may include one or more dictionaries or other lexicons (e.g., a common lexicon) for mapping the generally non-standardized data from the various SOR to a common format or definition for storage and later use in the enterprise object models as described in greater detail herein.

The integration framework module 128 may interpret input data from the SOR and output data, which data may exist in complex format and may provide the data for storage in a usable (i.e., consumable) or final format (e.g., without technical symbols, operators, text, etc.). The integration framework module 128 may set up an integration between the data collected from the SOR 104 and the raw data storage module 130 for temporary storage within the tech fabric 106, for example, the integration framework module 128 may dynamically process data from a format sent from the SOR for consumption by an API associated with the final generated product or one or more iterative steps before the final generated product. The integration framework module 128 may provide a core set of data pipeline rules or minimum standards for consumption and transformation in the tech fabric 106 (e.g., one or more rules, policies, modules, databases, and/or applications). That is, the integration framework module 128 may transform, cleanse, prepare and/or otherwise manipulate the data into a more usable or useful form. The integration framework module 128 may store information regardless of storage platform (i.e., platform agnostic) and may be located in one or more virtual servers running in a cloud-based environment running one or more virtual machines, for example, which may execute the integration framework module 128.

The raw data storage module 130 may receive and store data received from the various SOR and converted using the customer data mapping config module 126. The raw data may be data that is useable and understandable by the various enterprise object models and stored in a standardized and acceptable format. The raw data formats usable by the enterprise object models may be assigned and controlled by one or more users of the system (e.g., the system admin 120, the business admin 122, etc.) The raw data storage module 130 may be updated routinely with data from the various SOR based on a schedule defined by one or more users of the system (e.g., the system admin 120, the business admin 122, etc.) In some embodiments, the raw data storage module 130 is cleared based on expiry of a particular tenant's (e.g., client's) access to the tech fabric 106 and associated systems, for example, data that is collected and transformed using the system 100 then stored in the raw data storage module 130 or other component of the tech fabric 106 may be deleted at a given time frame after a project completion. For example, the stored data may be automatically deleted within a week of providing a completed project to a client or other user.

The raw data storage module 130 may store the raw data from the various SOR 104 to be populated into the enterprise object models which will be used to generate portions of a report as described herein. The raw data storage module 130 may store the raw data with one or more vendor specific characteristics and there may be no or fewer rules associated with raw data storage than with the storage of the data in the enterprise object model storage module 132.

In some embodiments, the raw data storage module 130 may be configured to perform additional data storage operations such as, for example, creating, storing, retrieving, and migrating storage data (e.g., storage data from the SOR 104) (which may include, for example, snapshot copies, backup copies, Hierarchical Storage Management (HSM) copies, archive copies, and other types of copies of electronic data) stored on storage devices. In some embodiments, storage operations may include storage operations copies of data, including informational lifecycle management (ILM), deduplication, content indexing, data classification, data mining or searching, collaborative searching, encryption and compression.

The enterprise object model storage module 132 may store one or more enterprise object models which are configured to query or access the data in the raw data storage module 130. The enterprise object models may be grouped into packages and may provide the raw data to a user in a useful, extensive, and well documented set of properties and methods that may be intuitive to a user for the generation of a final product. The enterprise object models may provide for the generation of and/or access to one or more diagrams, features, elements, metadata or other representations based on the raw data (e.g., charts, graphs, etc.) The enterprise object models may provide standardized access to the raw data from the various SOR to the various applications and modules of the system 100. The enterprise object models module 132 may thus provide a user with a set of standardized tools for generating custom reports and/or performing ad hoc queries to the databases an modules associated with the system 100.

For example, the enterprise object models may create one or more objectified view(s) of work processes, work products, behaviors, outcomes, and other data (“viewable workflow instance”) (e.g., a success rate of a particular medicament at treating an ailment) and may provide access to such data via an access component that may provide access to the viewable workflow instance such that customizable features of the instance can be defined (e.g., for user manipulation during run time). In some embodiments, customizable features may include, for example, charts, graphs, texts, and the like, which may be presented to a user via, for example, the data access layer 134. In some embodiments, the viewable workflow instance may be accessed directly (e.g., via the data access layer 134) such that the instance can be interacted with as a visible object type or class. In some embodiments, the enterprise object model storage module 132 may be customizable by a user such that a base definition can be used to generate one or more novel workflow definitions with one or more customizable properties, events, methods, etc.

Still referring to FIG. 3, the data access layer 134 may include a mapping module (not shown), which mapping module may be configured to execute a mapping technique (e.g., a generic mapping technique) to one or more object requests, which may be provided through the tech fabric 106 or the generated product 136. The data access layer 134 may specify how the requested objects map to a database, such as the faw data storage module 130, for example. The mapping or config files may be stored in, for example, XML files, and the data access layer 134 may process these XML files to build a representation of the data stored in XML files. In some embodiments, if the data access layer 134 receives one or more requests to retrieve objects (e.g., an object request), the data access layer 134 may process its in-memory representation of the mapping to generate one or more SQL queries for the database. The data access layer 134 may then execute the one or more queries and packages the results. The data access layer 134 may be configured to handle up to all retrieval requests.

The data access layer 134 may provide access to a front end consumer of data (e.g., a front end server). The data access layer 134 may be implemented, for example, on the network 102 such that it is implement on the same server as the tech fabric 106 and/or may be implemented on another server, which other server may be communicatively coupled with the network 102. The various programs and APIs of the report generation tool 136 may access the tech fabric 106 via the data access layer 134 such that the data access layer 134 configures the interaction between the data storage resources (e.g., the various SOR 104) and may minimize or obscure (in the eyes of a user of the system) the complexities of the underlying resources from the other layers of the system and/or network 102. The data access layer 134 may be, for example, a web server. The data access layer 134 may include multiple layers (not shown) including, for example, a business logic layer, a data layer, and a presentation layer. As mentioned above, the data access layer 134 may include mapping module which may include one or more applications or program which may serve as a data locator or data locator service that may facilitate location of one or more active partitions of a database. For example, the data access layer 134 may request a location of active (or “live”) data or inactive data from a data locator service before generating requests to avoid the attempted or achieved retrieval of erroneous data.

The generated product 136 may be, for example, a custom report, which may be viewable using the application user interface 138. The application user interface 138 may be configured to direct a computing device executing a software application to provide a user interface through which a user of the computing device may interact with the software application (e.g., by navigating application menus, associated menu options, etc.) Application user interface 138 may be configured, for example, to generate a GUI and direct a computing device executing a software application to provide one or more views of the GUI for display on a display screen. The GUI may be configured, for example, with a GUI window framework.

The application setup and validation module 140 may be executed to validate and verify that an associated application meets design and development requirements. The application configuration module 142 may select content to be included in one or more applications from the enterprise object model storage module 132 and may generate, for example, one or more configuration templates for various applications (e.g., the final generated product) and may transmit one or more configuration templates to one or more other modules of the system 100 for further use. The application configuration may be based on an application configuration request, which may be received based on a user input (e.g., a system admin 120 input, a business admin 122 input, etc.) The workflow engine 160 may be configured to allocate one or more tasks, to generate one or more schedules, or to assign one or more tasks to various users of the system 100 (e.g., the system admin 120, the business admin 122, etc.) The workflow engine 160 may dynamically adjust one or more steps in a sequence of workflow based on, for example, a result of one or more preceding steps in a workflow (e.g., generation of a report). The one or more preceding steps may be received automatically from devices associated with one or more users of the system 100 or other network components. The workflow engine 160 may iteratively fine-tune one or more steps in the generation of a final product until an acceptable final product has been created. Artifacts/results service module 152 may include one or more software and/or hardware components including executable instructions that may cause or enable report artifacts and/or results (e.g., test results, laboratory results, etc.) to be removed from and/or presented in a final product (e.g., a report).

The data cleansing module 150 may include software and/or hardware components including executable instructions that may change and/or remove suspect data from the final report. In some embodiments, the data cleansing module 150 may be configured to remove all data once a final report or final product has been generated, approved, and provided to an external system. The data cleansing module 150 may map, sort, and label data as data which should be cleansed or retained after the generation and subsequent delivery of a final product such that data necessary to the generation of further final products is maintained. The data cleansing module 150 may be configured to cleanse data on a schedule or on demand (e.g., at the demand of a system admin 120, a business admin 122, etc.)

The analysis service module 144 may be configured to perform anomaly detection and decision support, which may be used to generate one or more reports regarding the effectiveness of the tech fabric 106 and associated systems and modules. The analysis service module 144 may provide data to one or more external or internal modules for monitoring and/or evaluation of the analysis provided in the final report. The notifier/delivery module 146 may provide notifications of various events during system operation and may deliver such notification to one or more users or other modules or aspects of the system 100. For example, the notifier/delivery module 146 may be configured to provide a business admin 122 a notification that a final product has been generated, that one or more of the configuration settings of the system has been changed, etc. The report generation module 148 may generate one or more final products (e.g., reports, charts, analyses, etc.) based on stored data from the SOR, instructions from the one or more users, templates stored in the system 100 and other aspects. The report generation module 148 may receive processed data from one or more of the other modules of the system 100 and may generate a report to be displayed to one or more users of the system 100. The report may contain, for example, charts, graphs, text, and other data generated based on the data obtained from the various SOR.

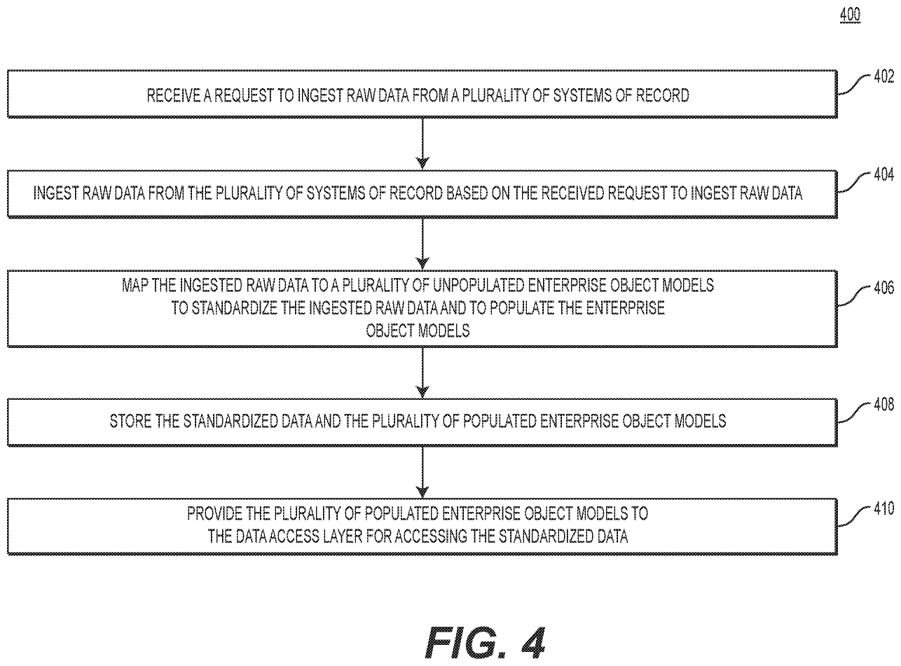

Referring now to FIG. 4, a method of accessing and integrating data from disparate data sources through a data access layer is described. At step 402, the system 100 may receive a request to ingest raw data from a plurality of systems of record. The request to ingest the data may come from, for example, a business admin 122 or other user of a system (e.g., an author/editor of a final report generated using the report generating tool 136). The SOR 104 may include multiple data sources, for example, the manufacturing execution systems (MES) 104a, the enterprise resource planning (ERP) system 104b, the electronic batch record (EBR) 104c, the quality management system (QMS) 104d, and one or more additional systems of record. The SOR 104 may include structured and unstructured data (e.g., collections of files, documents, sheets, etc.) In some embodiments, the SOR 104 may include and/or be configured to provide stored and/or real time data. The SOR 104 may be implemented, for example, on a computer system running a database management system such that the request to retrieve the raw data is provided through the database management system. The request may be provided to one or more of the SOR 104 and if related data in the various SOR 104 disagrees, the database management system may supply a data hierarchy for determining which of the data should control (i.e., serve as the data source). The systems of record may be communicatively coupled with one or more external servers. The requested raw data may be in any form and similar data types may be in various forms in each or any of the plurality of systems of record such that there is no common data format.

At step 404, the raw data may be ingested from the plurality of systems of record based on the received request. The raw data may include information such as a number of items produced, a number of items produced meeting a particular standard, a type of product generated, an efficiency output, a number of personnel hours expended on a particular project, and other industrial data.

In some embodiments, the ingested raw data may be transformed and/or processed using, for example, the data transformation module 170. The data may be transformed, converted, and/or translated once it has been acquired from the SOR 104 for use by the tech fabric 106. In some embodiments, the transformation module 170 may parse data structures acquired from the SOR 104 transform the received data into a format that is compatible for use with one or more other components of the system 100 (e.g., one or more other modules or for storage in a database). The tech fabric 106 may comprise multiple data transformation modules 170 and each may be configured to transform data from one or more of the individual SORs 104a, 104b, etc. (e.g., data transformation modules that are specific to a particularly formatted data from a particularly formatted SOR).

In some embodiments, the received data may be audited and/or tracked based on user identities once it has been received. The system 100 may use the audit trail/logging module 172, for example, to audit and/or track the received data. The audit trail/logging module 172 may track requests for identity verification and any response thereto from any of the various users of the system 100. In some embodiments, the audit trail/logging module 172 may be configured to track or monitor services performed by various users of the system and by the various components of the system (e.g., one or more servers). The audit trail/logging module 172 may record a detailed log of actions and events which occur with respect to the data within the system 100 such that the system administrator 120 or other user may identify and locate sources of error.

At step 406, the ingested raw data may be mapped to a plurality of unpopulated enterprise object models to standardize the ingested raw data and to populate the enterprise object models. The enterprise object models may, for example, read a data dictionary to create a default model (e.g., by reading a lexicon from a database, etc.) and the default model can be tailored to suit the needs of a final generated product (e.g., a report). The enterprise object models may be used to specify one or more enterprise object classes for various entities and features within the model and may be used to generate source code files for specified enterprise object classes.

At step 408, the standardized data and the plurality of populated enterprise object models may be stored. The data and the enterprise object models may be stored temporarily within the tech fabric 106. More specifically, the standardized data and the plurality of populated enterprise object models may be configured to automatically delete after a given time from generation of a final product. The data may be automatically deleted to create sufficient room for more data and to ensure that legacy data does not affect the generation of subsequent final products. The data and plurality of enterprise object models may be stored such that they are accessible to a data access layer for providing the data for incorporation in a final product.

At step 410 the plurality of populated enterprise object models may be provided to the data access layer for accessing the standardized data (e.g., through incorporation in a report). In some embodiments, access to the enterprise object models and standardized data may be accessed based on user permissions, which permissions may be enabled using, for example, two-factor authentication. The data access layer may be configured to execute a mapping technique to one or more object requests (e.g., enterprise objects) in order to provide the generated product 136 with data from the tech fabric 106.

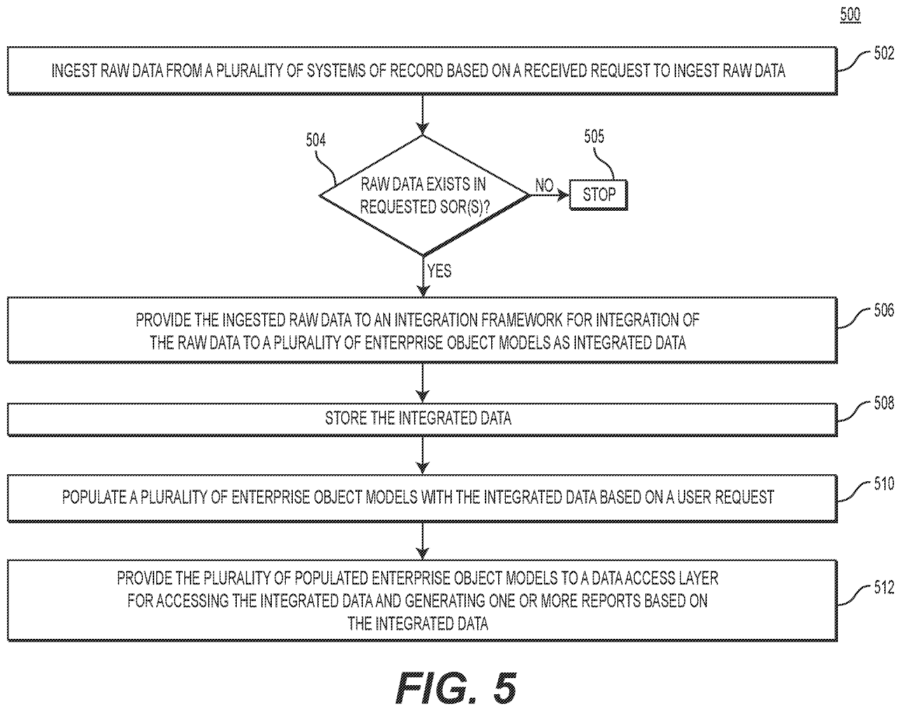

Referring now to FIG. 5, a method for providing data for presentation in a report through a data access layer is provided. The report may be based on data collected over a specified time frame, for example, data collected over the course of a year. The report may further include one or more permission requirements, which permission requirements may be used to approve or deny one or more aspects of the report.

At step 502, raw data may be ingested from a plurality of systems of record based on a received request to ingest raw data. In some embodiments, the request to ingest raw data may come from a user (e.g., a system admin 120, a business admin 122, etc.) In some embodiments, the request to ingest raw data may only be received based on an identity of the requester (i.e., if the identity of the requester is associated with the appropriate permissions as determined by the permissions module 176, for example, if the identity is verified by two-factor or multi-factor authentication, for example, etc.) The request may include one or more features or data requirements and data meeting these requirements may only be ingested. For example, the request may include one or more specified systems from the plurality of SOR 104 and may specifically exclude or not include a request for data from other of the SOR 104. The data requested may include information related to, for example, sales numbers, productivity numbers, product names, product strengths, ingredient lists, labels, storage information, packaging information, expiration dates, and other information related to a product or for generating a report related to the product. The request may come from one or more computers or users with access to the network 102 and may generally come at any point throughout the process of generating a report.

At step 504, it may be determined whether raw data exists from a particular SOR 104. The determination may be made based on, for example, meta data associated with the request (e.g., the information type). For example, if data is requested from a SOR in which the particular data does not exist, the process 500 may stop at step 505. If the data exists within the particular SOR and is accessible by the user, the process may continue.

At step 506, the ingested raw data may be provided to an integration framework for integration of the raw data to a plurality of enterprise object models for eventual objectification within a final report. Within the integration framework, the data may be processed, converted, or manipulated from the format in which it is stored in the SOR such that it can autopopulate one or more enterprise object models for viewing in a report. For example, data associated with the number of medication produced over a given time period may autopopulate an enterprise object model (e.g., a chart) showing a number of medication produced over the determined time frame (e.g., a year over a period of months). In some embodiments, the ingested raw data may be integrated using the integration framework module 128, which may set up an integration between the data collected from the SOR 104 and the raw data storage module 130 and/or the enterprise object model storage 132 for temporary storage within the tech fabric 106. Because the raw data may be sent from the particular SOR in a format which may not be operable by the report generator, the integration framework module 128 may dynamically process the ingested data for consumption by one or more APIs associated with the final generated product or for integration with one or more other products through the data access layer 134 via one or more core sets of data pipeline rules or minimum standards for consumption and transformation in the tech fabric 106 (e.g., one or more rules, policies, modules, databases, and/or applications). That is, the integration framework module 128 may transform, cleanse, prepare and/or otherwise manipulate the data into a more usable or useful form.

At step 508, integrated data may be stored. The integrated data may be stored, for example, in the raw data storage 130, the enterprise object model storage 132 as one or more enterprise object models, or in another location. The integration framework module 128 may store information regardless of storage platform (i.e., platform agnostic) and may be located in one or more virtual servers running in a cloud-based environment running one or more virtual machines, for example, which may execute the integration framework module 128.

In some embodiments, the integrated raw data may be stored temporarily such that it automatically deletes within a particular time frame (e.g., one month, two months, one year, etc.) Based on the integrated raw data automatically deleting after a given time frame, the particular tenant providing the raw data can know that the integrated raw data will not be reused after the given time frame.

At step 510, a plurality of enterprise object models may be populated with the integrated data based on a user request (e.g., a user request from the report generation module 148). In some embodiments, the populated enterprise object models may have been packaged into one or more convenient packages such that they can provide raw or processed data from the SOR 104 and/or the raw data storage module to a user in a useful, extensive, and well documented set of objects with properties and methods that may be intuitive to a user for the generation of a final product (e.g., an APQR). The enterprise object models may provide for the generation of and/or access to one or more diagrams, features, elements, metadata or other representations based on the raw data (e.g., charts, graphs, etc.)

The enterprise object models may provide standardized access to the raw data from the various SOR to the various applications and modules of the system 100. The enterprise object models module 132 may thus provide a user with a set of standardized tools for generating custom reports and/or performing ad hoc queries to the databases an modules associated with the system 100. For example, the enterprise object models may create one or more objectified view(s) of work processes, work products, behaviors, outcomes, and other data (“viewable workflow instance”) (e.g., a success rate of a particular medicament at treating an ailment) and may provide access to such data via an access component that may provide access to the viewable workflow instance such that customizable features of the instance can be defined (e.g., for user manipulation during run time).

At step 512, the plurality of populated enterprise object models may be provided to a data access layer for access and report generation. The data access layer 134 may include one or more modules (e.g., a mapping module), which modules may be configured to execute one or more mapping technique based on the one or more object requests. In some embodiments, the data access layer 134 may not be accessible by normal users of the system 100, but may only be accessible by one or more admins (e.g, the system admin 120, the business admin 122, etc.) such that the APIs and various processes within the data access layer 134 perform their functions transparent to the various users of the system. Accordingly, the data access layer 134 may specify how the requested objects map to a database without any input from an ordinary user of the system based on the rules and processes stored in the data access layer 134. The mapping or config files may be stored in, for example, XML files, and the data access layer 134 may process these XML files to build a representation of the data stored in XML files.

In some embodiments, if the data access layer 134 receives one or more requests to retrieve objects (e.g., an object request based on a request for raw data such as at step 502), the data access layer 134 may process its in-memory representation of the mapping to generate one or more SQL queries for the database. The data access layer 134 may then execute the one or more queries and packages the results. The data access layer 134 may be configured to handle up to all retrieval requests. The data access layer 134 may provide access to an author and/or editor of the report to be generated using the report generation tool.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

1. A method of accessing data from disparate data sources at a data access layer, the method comprising:
receiving a request to ingest raw data from a plurality of external systems of record;
ingesting raw data from the plurality of systems of record based on the received request to ingest raw data;
mapping the ingested raw data to a plurality of unpopulated enterprise object models to standardize the ingested raw data and to populate the enterprise object models;
storing the standardized data and the plurality of populated enterprise object models;
providing the plurality of populated enterprise object models to the data access layer for accessing the standardized data; and
creating one or more objectified view of a workflow by using the standardized data based on the request.

2. The method of claim 1, wherein the plurality of enterprise object models is mapped from the ingested raw data to a common lexicon.

3. (canceled)

4. The method of claim 1, further comprising transforming the collected raw data before the data is mapped to the plurality of enterprise object models, and wherein the collected and transformed raw data is deleted at a given time frame after a project completion.

5. (canceled)

6. (canceled)

7. (canceled)

8. The method of claim 1, wherein the collected raw data is mapped to the plurality of enterprise object models within a data lake.

9. The method of claim 1, wherein the plurality of external systems of record are the systems of record of a client and each of the plurality of external systems of record is accessible through an application programming interface, and wherein the plurality of external systems of record include one or more of a manufacturing execution system, an enterprise resource planning system, an electronic batch record system, and a quality management system.

10. The method of claim 1, wherein the data access layer is configured to receive one or more electronic validations to validate the provided plurality of enterprise object models.

11. A method for providing data for presentation in a report through a data access layer, the method comprising:
ingesting raw data from a plurality of external systems of record based on a received request to ingest raw data;
providing the ingested raw data to an integration framework for integration of the raw data to a plurality of enterprise object models as integrated data;
storing the integrated data;
populating a plurality of enterprise object models with the integrated data based on a user request;
providing the plurality of populated enterprise object models to a data access layer for accessing the integrated data and generating one or more reports based on the integrated data; and
creating one or more objectified view of a workflow by using the integrated data based on the user request.

12. The method of claim 11, wherein the integration framework includes a common lexicon for converting raw data to a common framework.

13. The method of claim 11, wherein the plurality of external systems of record include one or more of a manufacturing execution system, an enterprise resource planning system, an electronic batch record system, and a quality management system.

14. The method of claim 11, wherein the ingested raw data is ingested over a particular time frame.

15. (canceled)

16. The method of claim 11, wherein the ingested raw data is real-time data that is provided to the integration framework for real-time integration of the raw data to the plurality of enterprise object models to provide real time enterprise object models to the data access layer.

17. The method of claim 16, wherein the real time enterprise object models are used to generate a real time report through the data access layer.

18. A system for providing processed data to a data access layer for the generation of a data-based product, the system comprising:
a processor communicatively coupled to a plurality of external systems of record;
a memory including one or more instructions that when executed by the processor cause the system to:
ingest raw data from at least one of the plurality of systems of record based on a received request to ingest raw data;
provide the ingested raw data to an integration framework for integration of the raw data to a plurality of enterprise object models as integrated data;
store the integrated data;
populate a plurality of enterprise object models with the integrated data based on a user request;
provide the plurality of populated enterprise object models to a data access layer for accessing the integrated data and generating one or more reports based on the integrated data; and
create one or more objectified view of a workflow by using the integrated data based on the user request.

19. The system of claim 18, wherein the data access layer is configured to receive one or more electronic validations to validate the provided plurality of enterprise object models.

20. The system of claim 18, wherein the ingested raw data is integrated to the plurality of enterprise object models within a data lake and the ingestion of the raw data is based on a multi-factor authentication.

21. The method of claim 1, further comprises:
auditing the raw data to monitor one or more services performed by the plurality of external systems to locate a source of an error associated with the raw data;
providing access to the workflow to define customizable features, and wherein the customizable features are at least one of: charts, graphs, and texts;
autopopulating the one or more enterprise object models for viewing in a report; and
allocating one or more tasks to generate one or more schedules and assign one or more tasks.

22. The method of claim 1, wherein creating the one or more objectified view of the workflow comprises creating at least one of: a work process, work products, behaviors, outcomes, and other data.

23. The system of claim 18, wherein the plurality of external systems of record includes one or more of a manufacturing execution system, an enterprise resource planning system, an electronic batch record system, and a quality management system.

24. The system of claim 18, wherein the system further comprises at least one of: a data storage module, an identity management module, a data transformation module, an audit logging module, a domain models module, and a permissions module, and wherein the data storage module further comprises one or more storage drives configured to retrieve the integrated data, and wherein the identity management module is configured to provide one or more identity services, and wherein the data transformation module is configured to translate the raw data, and wherein the audit logging module is configured to track one or more services performed by the users of the system, and wherein the domain models module is configured to store one or more relationships of the raw data in a lexicon, and wherein the permission module is configured to determine whether the user is configured to access one or more parts of the integrated data.

25. The system of claim 18, wherein the system further comprises a workflow engine, wherein the workflow engine is further configured to: allocate one or more tasks, generate one or more schedules, and assign one or more tasks.
